(19) United States
(12) Patent Application Publication
(10) Pub. No.: US 2020/0094191 A1
(43) Pub. Date: Mar. 26, 2020

(54) FILTRATION APPARATUS

(71) Applicant: SUMITOMO ELECTRIC INDUSTRIES, LTD., Osaka-shi, Osaka (JP)

(72) Inventors: Hiroko MIKI, Sennan-gun, Osaka (JP); Keiichi IKEDA, Sennan-gun, Osaka (JP); Toru MORITA, Sennan-gun, Osaka (JP)

(73) Assignee: SUMITOMO ELECTRIC INDUSTRIES, LTD., Osaka-shi, Osaka (JP)

(21) Appl. No.: 16/468,729

(22) PCT Filed: Jun. 19, 2017
(86) PCT No.: PCT/JP2017/022487

§ 371 Date: Jun. 12, 2019

(30) Foreign Application Priority Data
Dec. 13, 2016 (JP) 2016-240906

(51) Int. Cl. B01D 63/02; B01D 65/02

(52) U.S. Cl. CPC B01D 63/02; B01D 65/08; B01D 65/02

(57) ABSTRACT

A filtration apparatus according to an aspect of the present invention includes a plurality of filtration modules each including a plurality of hollow fiber membranes aligned so as to extend in an up-and-down direction, a bar-like upper holding member configured to secure upper ends of the hollow fiber membranes, and a bar-like lower holding member configured to secure lower ends of the hollow fiber membranes; a cleaning module configured to supply bubbles from below the filtration modules; a frame including a plurality of vertical frame members disposed to extend in the up-and-down direction and a plurality of lateral frame members disposed to extend in lateral directions, the frame being configured to hold the filtration modules and the cleaning module; and a plurality of lower guide rails configured to engage with the lower holding members and disposed between opposite faces of the lateral frame members, wherein at least part of the cleaning module is suspended from the frame.

### TECHNICAL FIELD

The present invention relates to a filtration apparatus.

The present application claims the benefit of Japanese Patent Application No. 2016-240906, filed Dec. 13, 2016, which is hereby incorporated by reference herein in its entirety.

### BACKGROUND

Conventionally, filtration apparatuses including bundles of hollow fiber membranes have been used, for example, as solid liquid separation treatment apparatuses for sewage treatment. Such a filtration apparatus is used while being immersed in the liquid to be treated. The filtration apparatus performs filtration by preventing impurities contained in the liquid to be treated from passing through the hollow fiber membrane surfaces while allowing others to pass into the hollow fiber membranes.

The filtration apparatus typically includes, for example, a plurality of filtration modules each including a plurality of hollow fiber membranes aligned so as to extend in an up-and-down direction, an upper holding member communicating with upper openings of the hollow fiber membranes, and a lower holding member configured to hold the lower part of the hollow fiber membranes. Generally, the filtration modules are immersed in the liquid to be treated in an immobilized state inside a frame. A known frame of the filtration apparatus is composed of cross bars which include upper cross bars disposed above the upper holding members of the filtration modules, and lower cross bars disposed below the lower holding members of the filtration modules (see Patent Literature 1).

### CITATION LIST

### Patent Literature

PTL 1: U.S. Patent Application Publication No. 2006/0118477

### SUMMARY OF INVENTION

A filtration apparatus according to an aspect of the present invention includes a plurality of filtration modules each including a plurality of hollow fiber membranes aligned so as to extend in an up-and-down direction, a bar-like upper holding member configured to secure upper ends of the hollow fiber membranes, and a bar-like lower holding member configured to secure lower ends of the hollow fiber membranes; a cleaning module configured to supply bubbles from below the filtration modules; a frame including a plurality of vertical frame members disposed to extend in the up-and-down direction and a plurality of lateral frame members disposed to extend in lateral directions, the frame being configured to hold the filtration modules and the cleaning module; and a plurality of lower guide rails configured to engage with the lower holding members and disposed between opposite faces of the lateral frame members, wherein at least part of the cleaning module is suspended from the frame.

### BRIEF DESCRIPTION OF DRAWINGS

FIG. 1 is a schematic perspective view illustrating a filtration apparatus according to an embodiment of the present invention.

FIG. 2 is a schematic perspective view illustrating part of FIG. 1, including a frame, guide rails, and a cleaning module.

FIG. 3 is a schematic side view of the frame and others illustrated in FIG. 1.

FIG. 4 is a schematic side view of an aeration tube header and others illustrated in FIG. 1.

FIG. 5 is a schematic front view of part of the filtration apparatus illustrated in FIG. 1.

FIG. 6 is a schematic perspective view of a filtration module illustrated in FIG. 1.

FIG. 7 is a schematic front view of the filtration module illustrated in FIG. 6.

FIG. 8 is a schematic side view of the filtration module illustrated in FIG. 6.

### DESCRIPTION OF EMBODIMENTS

### Problems to be Solved by the Present Disclosure

In the conventional filtration apparatus described in Patent Literature 1, lateral frame members on the lower side are located below the filtration modules. When the lateral frame members are positioned this way, the presence of the lateral frame members makes it difficult to secure a flow path which is large enough to accommodate inflow of the liquid to be treated from below the filtration modules. If a flow path large enough to accommodate inflow of the liquid to be treated cannot be secured, the filtration efficiency may be degraded. Also, the technique disclosed in Patent Literature 1 does not fully take into consideration the cleaning of the hollow fiber membranes or, more specifically, removal of impurities adhering to the hollow fiber membrane surfaces, during filtration.

The present invention has been made on the basis of the circumstances described above. An object of the present invention is to provide a filtration apparatus that enables sufficient cleaning of hollow fiber membranes during filtration and secures a flow path for the liquid to be treated below filtration modules.

### Advantageous Effects of the Present Disclosure

The present invention can provide a filtration apparatus that enables sufficient cleaning of hollow fiber membranes during filtration and secures a flow path for the liquid to be treated below filtration modules.

### Description of Embodiments of the Present Invention

First, embodiments of the present invention will be summarized.

A filtration apparatus according to an aspect of the present invention includes a plurality of filtration modules each including a plurality of hollow fiber membranes aligned so as to extend in an up-and-down direction, a bar-like upper holding member configured to secure upper ends of the hollow fiber membranes, and a bar-like lower holding member configured to secure lower ends of the hollow fiber membranes; a cleaning module configured to supply bubbles from below the filtration modules; a frame including a plurality of vertical frame members disposed to extend in the up-and-down direction and a plurality of lateral frame members disposed to extend in lateral directions, the frame being configured to hold the filtration modules and the cleaning module; and a plurality of lower guide rails configured to engage with the lower holding members and disposed between opposite faces of the lateral frame members, wherein at least part of the cleaning module is suspended from the frame.

In the filtration apparatus, the lower guide rails disposed between the opposite faces of the lateral frame members engage with the lower holding members to allow the filtration modules to be held by the frame. This means that bubbles supplied from the cleaning module can come into direct contact with the filtration modules without being blocked by other components. With this structure, impurities adhering to the hollow fiber membrane surfaces can be sufficiently removed. Also, in the filtration apparatus, the lower holding members of the filtration modules are positioned at the same height as the lateral frame members that support the lower holding members, with the lower guide rails. At the same time, the filtration apparatus has a structure in which at least part of the cleaning module is suspended from the frame. Therefore, the filtration apparatus can secure, under the filtration modules, a flow path that is large enough to accommodate inflow of the liquid to be treated from therearound. Thus, with the filtration apparatus, filtration of the liquid to be treated can be done efficiently.

It is preferable that at least part of the cleaning module be suspended from at least one of the lateral frame members, with a plurality of belt-shaped securing members interposed therebetween, the belt-shaped securing members being arranged to be spaced apart from each other. This configuration facilitates, for example, removal of the cleaning module for maintenance. With the suspension structure using the belt-shaped securing members, the belt-shaped securing members make it possible to secure a space that is large enough to facilitate flow of the liquid to be treated into the frame. This further improves filtration efficiency.

It is preferable that at least one of the lateral frame members be disposed so as to be positioned outside the vertical frame members. This makes relatively easy, for example, the removal of the lateral frame member for maintenance, and further improves work efficiency during maintenance and assembly.

The cleaning module preferably includes an aeration tube and an intermittent bubble discharge unit disposed above the aeration tube. In the filtration apparatus, bubbles supplied from the intermittent bubble discharge unit, which is included in the cleaning module, can come into direct contact with the filtration modules without being blocked by other components. With this structure, impurities adhering to the hollow fiber membrane surfaces can be sufficiently removed.

Note that “at least part of the cleaning module is suspended from the frame” refers to either the state where at least part of the cleaning module is suspended in direct contact with the frame, or the state where at least part of the cleaning module is suspended from the frame, with one or more components interposed therebetween. For example, the cleaning module may extend between a plurality of components suspended from the frame. Any configuration is applicable, as long as at least part of the cleaning module is suspended from the frame. This means that another part of the cleaning module may not necessarily need to be suspended, and may be, for example, disposed on the upper face of the frame. Also, the “suspended cleaning module” may be suspended from the frame while being completely immobilized, or may be swingably suspended from the frame.

### Details of Embodiments of the Present Invention

A filtration apparatus according to an embodiment of the present invention will now be described with reference to the drawings.

[Filtration Apparatus]

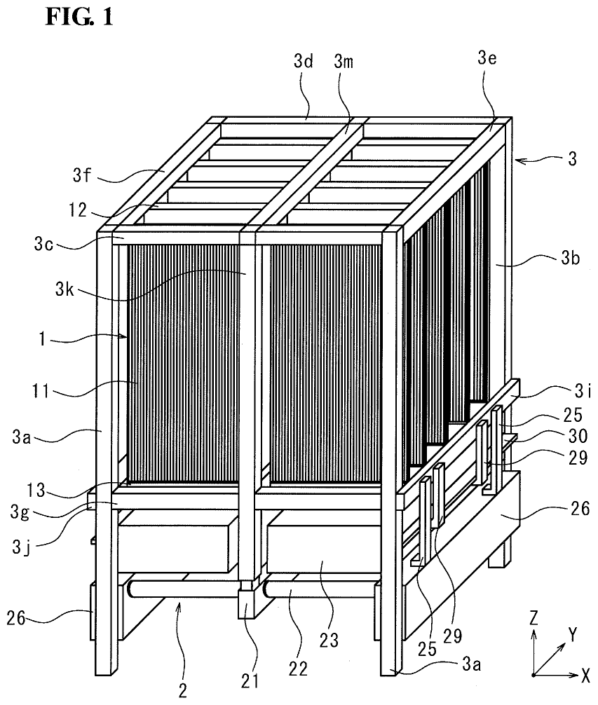

A filtration apparatus according to an embodiment of the present invention illustrated in FIG. 1 and others is used while being immersed in the liquid to be treated. The filtration apparatus performs filtration by preventing impurities contained in the liquid to be treated from passing into hollow fiber membranes 11 while allowing others to pass into the hollow fiber membranes 11. As illustrated in FIGS. 1 to 5, the filtration apparatus mainly includes a plurality of filtration modules 1, a cleaning module 2, a frame 3 configured to hold the filtration modules 1 and the cleaning module 2, and a plurality of guide rails 4. The guide rails 4 include upper guide rails 4a and lower guide rails 4b.

<Filtration Module>

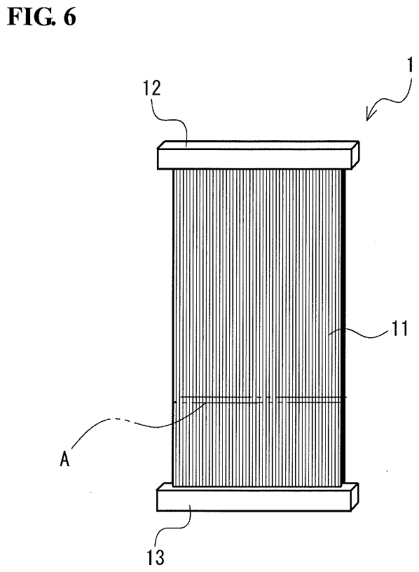

As illustrated in FIGS. 6 to 8, the filtration modules 1 each include a plurality of hollow fiber membranes 11 aligned so as to extend in an up-and-down direction, and a pair of bar-like holding members each configured to secure either upper or lower ends of the hollow fiber membranes 11. The pair of holding members is composed of an upper holding member 12 and a lower holding member 13. The hollow fiber membranes 11 are secured at the upper ends thereof by the bar-like upper holding member 12 and secured at the lower ends thereof by the bar-like lower holding member 13. The hollow fiber membranes 11 are thus aligned so as to extend in the up-and-down direction, and are arranged side by side in a curtain-like manner along the longitudinal direction of the upper holding member 12 and the lower holding member 13. As used herein, the term “bar-like” refers to a long and narrow shape. More specifically, this means that the length in the longitudinal direction is greater than or equal to four times the maximum length in the direction perpendicular to the longitudinal direction. Also, the “hollow fiber membranes are arranged side by side in a curtain-like manner” means that in a cross-section perpendicular to the direction in which the hollow fiber membranes 11 extend, the existence region of the hollow fiber membranes 11 has a long axis along the longitudinal direction of the pair of holding members.

The following explanation is based on the assumption that in FIG. 1, the up-and-down direction is the Z-direction, the longitudinal direction of the upper holding member 12 and the lower holding member 13 is the X-direction, and the direction perpendicular to the X-direction in the horizontal direction is the Y-direction.

The hollow fiber membranes 11 are arranged in parallel at substantially equal intervals. The term “substantially equal intervals” means that variation in interval is within 10% and preferably within 5%. The term “parallel” means substantially parallel, and means that the angle formed by opposite sides is −5° or greater and 5° or smaller.

Specifically, the filtration modules 1 are arranged in two rows along the Y-direction in such a manner that, in a cross-section perpendicular to the direction in which the hollow fiber membranes 11 extend, the long sides (extending in the X-direction) of existence regions A of the hollow fiber membranes 11 (see FIGS. 1 and 6) are parallel. The existence regions A are preferably in the shape of a rectangular having these long sides and short sides perpendicular thereto. As illustrated in FIG. 1, the filtration modules 1 in each row are arranged at predetermined intervals in the short-side direction of the existence regions A (i.e., in the Y-direction). Thus, in plan view, the filtration modules 1 form a striped pattern defined by the filtration modules 1 and the spaces between adjacent ones of the filtration modules 1. The filtration modules 1 are preferably arranged in a matrix in the long-side direction and the short-side direction of the existence regions A. The filtration modules 1 will be described in detail later on.

<Frame>

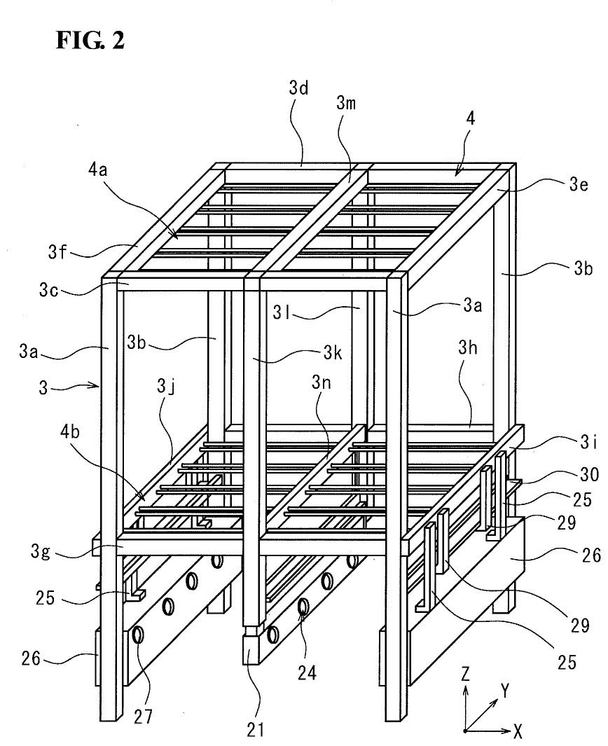

The frame 3 forms a support structure of the filtration apparatus. The frame 3 directly or indirectly holds the filtration modules 1 and the cleaning module 2. The frame 3 includes a plurality of frame members 3a to 3n. Specifically, as illustrated in FIGS. 1, 2, and others, the frame members 3a to 3n include a pair of front-side vertical frame members 3a and a pair of back-side vertical frame members 3b that extend in the Z-direction to form four corners of the support structure in plan view. The frame members 3a to 3n also include the front-side upper frame member 3c, the back-side upper frame member 3d, the right-side upper frame member 3e, and the left-side upper frame member 3f rectangularly arranged in plan view and each suspended between corresponding ones of the upper portions of the front-side vertical frame members 3a and back-side vertical frame members 3b; and the front-side lower frame member 3g, the back-side lower frame member 3h, the right-side lower frame member 3i, and the left-side lower frame member 3j rectangularly arranged in plan view and each suspended between corresponding ones of the lower portions of the front-side vertical frame members 3a and back-side vertical frame members 3b.

The frame members 3a to 3n further include the front-side support frame member 3k suspended between the centers of the front-side upper frame member 3c and the front-side lower frame member 3g in the axial direction, and the back-side support frame member 3l suspended between the centers of the back-side upper frame member 3d and the back-side lower frame member 3h in the axial direction. Additionally, the frame members 3a to 3n include the upper support frame member 3m suspended between the centers of the front-side upper frame member 3c and the back-side upper frame member 3d in the axial direction, and the lower support frame member 3n suspended between the centers of the front-side lower frame member 3g and the back-side lower frame member 3h in the axial direction.

In the frame 3, the pair of front-side vertical frame members 3a, the pair of back-side vertical frame members 3b, the front-side support frame member 3k, and the back-side support frame member 3l are vertical frame members extending in the up-and-down direction or Z-direction. The front-side upper frame member 3c, the back-side upper frame member 3d, the right-side upper frame member 3e, the left-side upper frame member 3f, the front-side lower frame member 3g, the back-side lower frame member 3h, the right-side lower frame member 3i, the left-side lower frame member 3j, the upper support frame member 3m, and the lower support frame member 3n are lateral frame members extending in lateral directions. Note that the lateral directions refer to horizontal directions, which include the X-direction and the Y-direction. In FIGS. 1 and 2, the right side refers to the X-direction side, and the left side is opposite the X-direction. Similarly, the back side refers to the Y-direction side, and the front side is opposite the Y-direction.

In the frame 3, the front-side upper frame member 3c and the back-side upper frame member 3d, which serve as a front-and-back upper frame pair, are horizontally arranged in parallel. The front-side lower frame member 3g and the back-side lower frame member 3h, which serve as a front-and-back lower frame pair, are horizontally arranged in parallel. Also, in the frame 3, the right-side upper frame member 3e and the left-side upper frame member 3f, which serve as a right-and-left upper frame pair, and the upper support frame 3m are horizontally arranged in parallel. The right-side lower frame member 3i and the left-side lower frame member 3j, which serve as a right-and-left lower frame pair, and the lower support frame member 3n are horizontally arranged in parallel.

In the frame 3, the right-side lower frame member 3i is disposed between the front-side vertical frame member 3a on the right side and the back-side vertical frame member 3b on the right side in such a manner as to be positioned outside the front-side vertical frame member 3a on the right side and the back-side vertical frame member 3b on the right side. That is, in FIG. 2, the right-side lower frame member 3i horizontally extends so as to be in contact with both the right side face of the front-side vertical frame member 3a on the right side and the right side face of the back-side vertical frame member 3b on the right side. Similarly, the left-side lower frame member 3j is disposed between the front-side vertical frame member 3a on the left side and the back-side vertical frame member 3b on the left side in such a manner as to be positioned outside the front-side vertical frame member 3a on the left side and the back-side vertical frame member 3b on the left side. That is, in FIG. 2, the left-side lower frame member 3j horizontally extends so as to be in contact with both the left side face of the front-side vertical frame member 3a on the left side and the left side face of the back-side vertical frame member 3b on the left side.

The right-side lower frame member 3i and the left-side lower frame member 3j, which are lateral frame members, are each detachably secured, with screws or the like, to the front-side vertical frame member 3a and the back-side vertical frame member 3b, which are vertical frame members.

<Guide Rail>

The upper guide rails 4a engage with the upper holding members 12 of the filtration modules 1. The lower guide rails 4b engage with the lower holding members 13 of the filtration modules 1.

As illustrated in FIG. 2, the upper guide rails 4a extend between lower faces of the right-side upper frame member 3e and the upper support frame member 3m which are horizontally arranged in parallel, and also between lower faces of the left-side upper frame member 3f and the upper support frame member 3m which are horizontally arranged in parallel. The upper guide rails 4a are thus disposed under the right-side upper frame member 3e, the left-side upper frame member 3f, and the upper support frame member 3m.

As illustrated in FIG. 2, the lower guide rails 4b are disposed between opposite faces of the lateral frame members which are horizontally arranged in parallel. Specifically, the lower guide rails 4b are disposed between the opposite faces of the right-side lower frame member 3i and the lower support frame member 3n, or more specifically, between the left side face of the right-side lower frame member 3i and the right side face of the lower support frame member 3n in FIG. 2. Also, the lower guide rails 4b are disposed between the opposite faces of the left-side lower frame member 3j and the lower support frame member 3n, or more specifically, between the right side face of the left-side lower frame member 3j and the left side face of the lower support frame member 3n in FIG. 2.

The upper guide rails 4a coincide with the respective lower guide rails 4b in plan view.

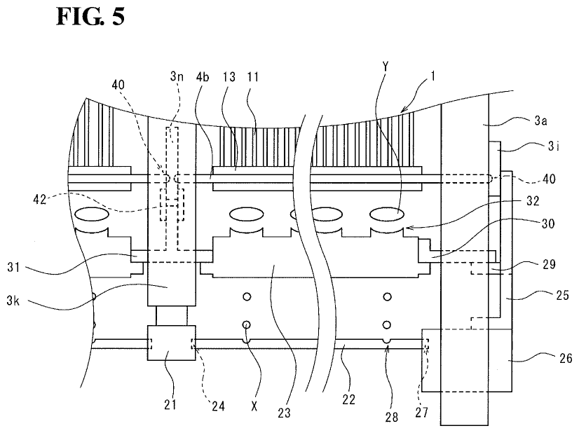

The opposite faces of the right-side lower frame member 3i, the left-side lower frame member 3j, and the lower support frame member 3n each have a plurality of holes 40 formed therein (see FIGS. 4 and 5) for insertion of the lower guide rails 4b. These frame members are each configured in such a manner that the lower guide rails 4b can be attached thereto by insertion of the end portions of the lower guide rails 4b into corresponding ones of the holes 40.

It is preferable, as illustrated in FIG. 2, that the guide rails 4 be pairs of round rods arranged in parallel. Alternatively, for example, the guide rails 4 may each be composed of a pair of plate-like portions facing both side faces of the lower holding member 13, and raised portions jutting out of the respective plate-like portions toward the lower holding member 13.

<Cleaning Module>

The cleaning module 2 supplies bubbles from below the filtration modules 1. As illustrated in FIGS. 1, 5, and others, the cleaning module 2 includes an aeration tube header 21, a plurality of aeration tubes 22, and a plurality of intermittent bubble discharge units 23 disposed above the aeration tubes 22. Aeration-tube support members 26 and metal securing pieces 30 and 31 (described below) are also included in the cleaning module 2. The cleaning module 2 is suspended from the frame 3. The structure of the cleaning module 2 will now be described.

As illustrated in FIGS. 2, 4, and others, the aeration tube header 21 is suspended so as to extend between the lower end of the front-side support frame member 3k and the lower end of the back-side support frame member 3l. Specifically, at one end of the aeration tube header 21, or more specifically, at the left end of the aeration tube header 21 in FIG. 4, the upper face of this end portion is coupled to the lower face of the front-side support frame member 3k. At the same time, the other end of the aeration tube header 21, or more specifically, the right end of the aeration tube header 21 in FIG. 4, is suspended from the back-side support frame member 3l, with a securing member 41 therebetween. The aeration tube header 21 is thus suspended from the front-side support frame member 3k and the back-side support frame member 3l.

The aeration tube header 21 is a structure for distributing gas to each of the aeration tubes 22 and has a tubular form. An inner cross-section of the aeration tube header 21 perpendicular to the central axis is not particularly limited in shape and may be, for example, rectangular, elliptic, perfectly circular, inverse T-shaped, or L-shaped. For example, with the cross-section having an inverse T-shape, this structure can facilitate formation of a gas layer in the upper part of the interior of the aeration tube header 21 while reducing the size of the aeration tube header 21 and hence the size of the filtration apparatus. The aeration tube header 21 has, on both side faces thereof, a plurality of hole portions 24 for distributing gas to each of the aeration tubes 22. The hole portions 24 may protrude and the protruding faces may have holes formed therein.

The aeration tube header 21 is continuously supplied with gas from, for example, a compressor (not shown) through a pipe.

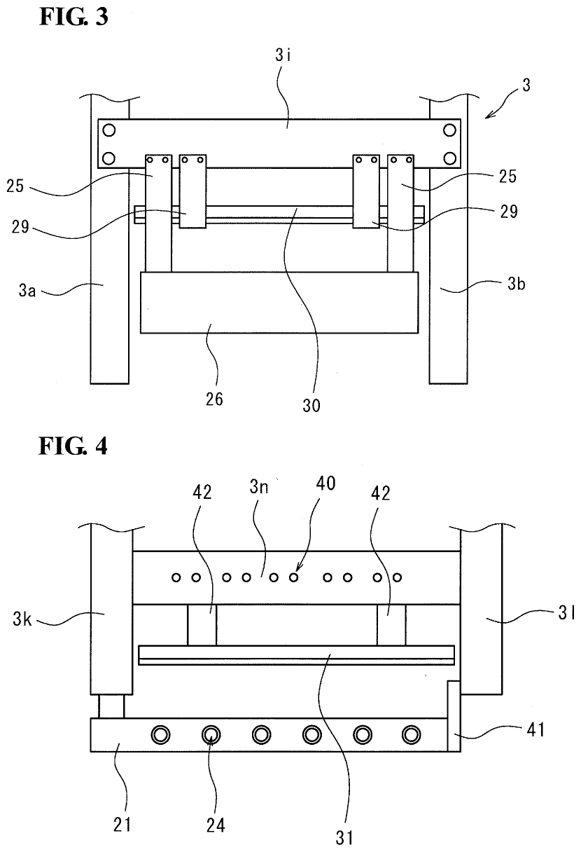

A pair of belt-shaped securing members 25 that are spaced apart is attached to the outer face of each of the right-side lower frame member 3i and the left-side lower frame member 3j (see, e.g., FIG. 3). The belt-shaped securing members 25 are attached so as to hang downward from the right-side lower frame member 3i or from the left-side lower frame member 3j. The belt-shaped securing members 25 are each bent at the lower part thereof into an L-shape so as to extend toward the inside of the frame 3. The aeration-tube support member 26 is attached to each pair of belt-shaped securing members 25 so as to be suspended therefrom. That is, the aeration-tube support member 26 is suspended from the right-side lower frame member 3i or from the left-side lower frame member 3j, with the pair of belt-shaped securing members 25 therebetween.

The aeration-tube support member 26 supports one end of each aeration tube 22. The aeration-tube support member 26 may be a sludge disposal box. The sludge disposal box is a device into which impurities, such as sludge and others, accumulated in the aeration tubes 22 are discharged. The inner side face of the aeration-tube support member 26 has hole portions 27 arranged in the horizontal direction for attachment of the aeration tubes 22. The hole portions 27 of the aeration-tube support member 26 may also have a protruding shape.

As illustrated in FIGS. 1 and 5, the aeration tubes 22 are each disposed between the aeration tube header 21 and the aeration-tube support member 26. Specifically, the aeration tubes 22 are each inserted, at one end thereof, into the hole portion 24 of the aeration tube header 21 and inserted, at the other end thereof, into the hole portion 27 of the aeration-tube support member 26. The aeration tubes 22 extend in parallel along the guide rails 4, or in the X-direction in FIG. 1. The aeration tubes 22 each have a plurality of bubble outlets 28 in the upper surface thereof. Each aeration tube 22 allows bubbles X to be continuously discharged through the bubble outlets 28.

A pair of belt-shaped securing members 29 that are spaced apart is attached to the outer face of each of the right-side lower frame member 3i and the left-side lower frame member 3j. The belt-shaped securing members 29 are disposed inside the belt-shaped securing members 25 from which the aeration-tube support member 26 is suspended. The belt-shaped securing members 29 are attached so as to hang downward from the right-side lower frame member 3i or from the left-side lower frame member 3j. The belt-shaped securing members 29 are each bent at the lower part thereof into an L-shape so as to horizontally extend toward the inside of the frame 3. The horizontal portions of the lower parts of each pair of belt-shaped securing members 29 have the metal securing piece 30 thereon for securing the intermittent bubble discharge units 23 in place. That is, the metal securing piece 30 is suspended from the right-side lower frame member 3i or from the left-side lower frame member 3j, with the pair of belt-shaped securing members 29 therebetween.

As illustrated in FIGS. 4 and 5, a pair of front and back securing members 42 is also suspended from the lower support frame member 3n. The metal securing piece 31 is suspended from the lower support frame member 3n, with the securing members 42 therebetween.

The intermittent bubble discharge units 23 are each disposed between the metal securing piece 30 suspended from the right-side lower frame member 3i or from the left-side lower frame member 3j and the metal securing piece 31 suspended from the lower support frame member 3n. In other words, the intermittent bubble discharge units 23 are suspended from the frame 3. Securing members, such as bolts (not shown), may be used to secure each of the intermittent bubble discharge units 23 to the metal securing piece 30 or to the metal securing piece 31. The intermittent bubble discharge units 23 disposed in this manner are positioned above the respective aeration tubes 22.

The intermittent bubble discharge units 23 each have a plurality of bubble outlets 32 formed in the upper surface thereof. The bubble outlets 32 in the intermittent bubble discharge units 23 are formed to be larger in diameter than the bubble outlets 28 in the aeration tubes 22. The shape of the bubble outlets 32 is not particularly limited and may be, for example, circular or square. The intermittent bubble discharge units 23 each also serve as a guide mechanism for accurately supplying bubbles Y to a desired location in the filtration module 1.

The intermittent bubble discharge units 23 are each configured to store therein gas supplied in the form of bubbles X from the aeration tube 22 under the intermittent bubble discharge unit 23, and then intermittently discharge the gas through the bubble outlets 32 each time the volume of gas reaches a certain level. The intermittent bubble discharge unit 23 can thus supply bubbles Y of relatively large diameters to the filtration module 1 (see FIG. 5).

The type of gas supplied from the cleaning module 2 is not particularly limited, as long as it is inert. To reduce running costs, it is preferable to use air.

(Hollow Fiber Membrane)

The hollow fiber membranes 11 are tubular porous membranes which allow passage of water therethrough and prevent passage of impurities contained in the liquid to be treated.

The main material used to form the hollow fiber membranes 11 may be thermoplastic resin. Example of the thermoplastic resin include polyethylene, polypropylene, polyvinylidene fluoride, ethylene-vinylalcohol copolymer, polyamide, polyimide, polyetherimide, polystyrene, polysulfone, polyvinyl alcohol, polyphenylene ether, polyphenylene sulfide, acetylcellulose, polyacrylonitrile, and polytetrafluoroethylene (PTFE). The most preferable among them is PTFE which is a porous material with high chemical resistance, heat resistance, weather resistance, and flame resistance. It is particularly preferable to use uniaxially or biaxially expanded PTFE. The material used to form the hollow fiber membranes 11 may contain, for example, other types of polymers or an additive, such as a lubricant, where appropriate.

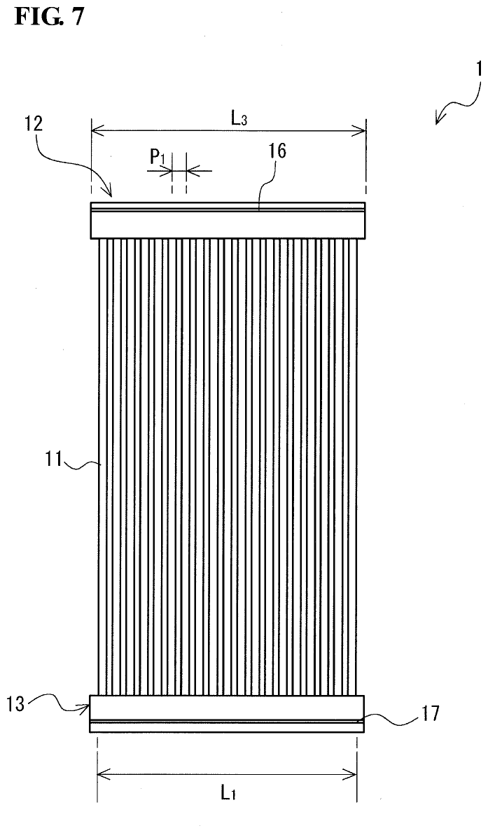

The lower limit of an average length L₁ (see FIG. 7) of the existence regions A (see FIG. 6) in the long-side direction is preferably 300 mm and more preferably 500 mm. The upper limit of the average length L₁ is preferably 1200 mm and more preferably 1000 mm. If the average length L₁ is below the lower limit, sufficient filtration efficiency may not be achieved. On the other hand, the average length L₁ exceeding the upper limit may make handling difficult.

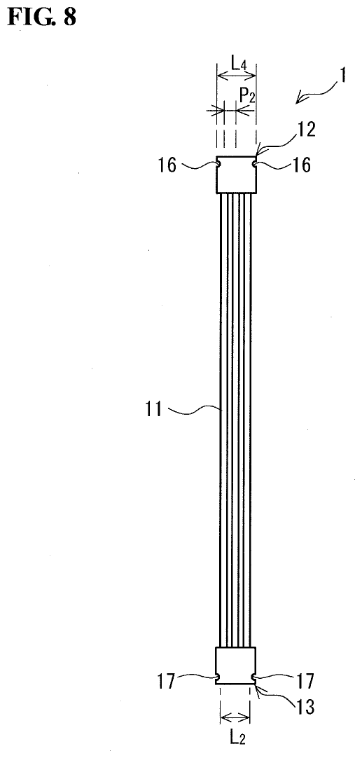

The lower limit of an average length L₂ (see FIG. 8) of the existence regions A in the short-side direction is preferably 10 mm and more preferably 15 mm. The upper limit of the average length L₂ is preferably 100 mm and more preferably 75 mm. If the average length L₂ is below the lower limit, sufficient filtration efficiency may not be achieved. On the other hand, if the average length L₂ exceeds the upper limit, bubbles discharged from the cleaning module 2 may not be accurately supplied to the center of the bundle of the hollow fiber membranes 11.

The lower limit of the ratio of the average length L₂ of the existence regions A in the short-side direction to the average length L₁ of the existence regions A in the long-side direction (L₂/L₁) is preferably 1/80 and more preferably 1/50. The upper limit of the ratio of the average length L₂ to the average length L₁ (L₂/L₁) is preferably 1/3 and more preferably 1/10. If the ratio of the average length L₂ to the average length L ₁ (L₂/L₁) is below the lower limit, the filtration modules 1 may be difficult to handle. On the other hand, if the ratio of the average length L₂ to the average length L₁ (L₂/L₁) exceeds the upper limit, bubbles discharged from the cleaning module 2 may not be accurately supplied to the center of the bundle of the hollow fiber membranes 11.

The lower limit of an average distance between the existence regions A in the filtration modules 1 adjacent in each row in the front and back direction, or the Y-direction in FIG. 1, is preferably 10 mm and more preferably 15 mm. The upper limit of the average distance between the existence regions A is preferably 30 mm and more preferably 25 mm. If the average distance between the existence regions A is below the lower limit, the filtration modules 1 may not be easily attached or removed. On the other hand, if the average distance between the existence regions A exceeds the upper limit, the resulting decrease in existence density of the filtration modules 1 may degrade the filtration efficiency.

An average pitch P₁ of the hollow fiber membranes 11 in the long-side direction is preferably greater than an average pitch P₂ of the hollow fiber membranes 11 in the short-side direction (see FIGS. 7 and 8). The lower limit of the ratio of the average pitch P₂ of the hollow fiber membranes 11 in the short-side direction to the average pitch P₁ of the hollow fiber membranes 11 in the long-side direction (P₂/P₁) is preferably 2/5 and more preferably 1/2. The upper limit of the ratio of the average pitch P₂ of the hollow fiber membranes 11 in the short-side direction to the average pitch P₁ of the hollow fiber membranes 11 in the long-side direction (P₂/P₁) is preferably 4/5 and more preferably 2/3. If the ratio (P₂/P₁) is below the lower limit, the density of the hollow fiber membranes 11 in the long-side direction may be too small to achieve sufficient filtration efficiency. On the other hand, if the ratio (P₂/P₁) exceeds the upper limit, bubbles discharged from the cleaning module 2 may not be fully introduced into the spaces between the hollow fiber membranes 11.

The lower limit of the filled area ratio of the hollow fiber membranes 11 in the existence regions A is preferably 20% and more preferably 30%. The upper limit of the filled area ratio of the hollow fiber membranes 11 in the existence regions A is preferably 60% and more preferably 55%. If the filled area ratio of the hollow fiber membranes 11 is below the lower, limit, the number of hollow fiber membranes 11 per unit area may be too small to achieve sufficient filtration efficiency. On the other hand, if the filled area ratio of the hollow fiber membranes 11 exceeds the upper limit, the spaces between the hollow fiber membranes 11 may be too small to allow bubbles discharged from the cleaning module 2 to be fully introduced into the spaces between the hollow fiber membranes 11.

The lower limit of the number of hollow fiber membranes 11 arranged in the short-side direction in each existence region A is preferably 8 and more preferably 12. The upper limit of the number of hollow fiber membranes 11 arranged in the short-side direction is preferably 50 and more preferably 40. If the number of hollow fiber membranes 11 arranged in the short-side direction is below the lower limit, sufficient filtration efficiency per unit area may not be achieved. On the other hand, if the number of hollow fiber membranes 11 arranged in the short-side direction exceeds the upper limit, bubbles discharged from the cleaning module 2 may not be fully introduced into the spaces between the hollow fiber membranes 11.

The lower limit of the ratio of the average pitch P₂ in the short-side direction to the average outside diameter of the hollow fiber membranes 11 is preferably 1. The upper limit of the ratio of the average pitch P₂ in the short-side direction to the average outside diameter of the hollow fiber membranes 11 is preferably 3/2 and more preferably 7/5. If the ratio of the average pitch P₂ in the short-side direction to the average outside diameter of the hollow fiber membranes 11 is below the lower limit, the hollow fiber membranes 11 are arranged in a compressed state in the radial direction, and this may make manufacture of the filtration modules 1 difficult. On the other hand, if the ratio of the average pitch P₂ in the short-side direction to the average outside diameter of the hollow fiber membranes 11 exceeds the upper limit, the density of the hollow fiber membranes 11 in the short-side direction may be too small to achieve sufficient filtration efficiency.

The lower limit of the average outside diameter of the hollow fiber membranes 11 is preferably 1 mm, more preferably 1.5 mm, and even more preferably 2 mm. The upper limit of the average outside diameter of the hollow fiber membranes 11 is preferably 6 mm, more preferably 5 mm, and even more preferably 4 mm. If the average outside diameter of the hollow fiber membranes 11 is below the lower limit, the mechanical strength of the hollow fiber membranes 11 may be insufficient. On the other hand, if the average outside diameter of the hollow fiber membranes 11 exceeds the upper limit, the resulting lack of flexibility of the hollow fiber membranes 11 may prevent the hollow fiber membranes 11 from sufficiently vibrating or swinging in contact with gas. This means that the hollow fiber membranes 11 may not be spaced apart to allow gas to pass therebetween. Also, the ratio of the surface area to cross-sectional area of the hollow fiber membranes 11 may be too small to maintain filtration efficiency.

The lower limit of the average inside diameter of the hollow fiber membranes 11 is preferably 0.3 mm, more preferably 0.5 mm, and even more preferably 0.9 mm. The upper limit of the average inside diameter of the hollow fiber membranes 11 is preferably 4 mm and more preferably 3 mm. If the average inside diameter of the hollow fiber membranes 11 is below the lower limit, a pressure drop during discharge of filtered liquid from inside the hollow fiber membranes 11 may increase. On the other hand, if the average inside diameter of the hollow fiber membranes 11 exceeds the upper limit, the thickness of the hollow fiber membranes 11 may be too small to ensure sufficient mechanical strength and effectiveness in blocking passage of impurities.

The lower limit of the ratio of the average inside diameter to average outside diameter of the hollow fiber membranes 11 is preferably 3/10 and more preferably 2/5. The upper limit of the ratio of the average inside diameter to average outside diameter of the hollow fiber membranes 11 is preferably 4/5 and more preferably 3/5. If the ratio of the average inside diameter to average outside diameter of the hollow fiber membranes 11 is below the lower limit, the thickness of the hollow fiber membranes 11 may be too large to maintain water permeability of the hollow fiber membranes 11. On the other hand, if the ratio of the average inside diameter to average outside diameter of the hollow fiber membranes 11 exceeds the upper limit, the thickness of the hollow fiber membranes 11 may be too small to ensure sufficient mechanical strength and effectiveness in blocking passage of impurities.

The lower limit of the average effective length of the hollow fiber membranes 11 is preferably 0.5 m and more preferably 0.8 m. The upper limit of the average effective length of the hollow fiber membranes 11 is preferably 6 m and more preferably 5 m. If the average effective length of the hollow fiber membranes 11 is below the lower limit, the hollow fiber membranes 11 may not sufficiently swing in frictional contact with gas flow. This means that the hollow fiber membranes 11 may not be spaced apart to allow gas to pass therebetween. On the other hand, if the average effective length of the hollow fiber membranes 11 exceeds the upper limit, the hollow fiber membranes 11 may excessively deform due to their own weight, or the filtration modules 1 may be difficult to handle during mounting or removal. Note that the term “average effective length” refers to the average length of the hollow fiber membranes 11 in exposed part.

The hollow fiber membranes 11 extending between the upper holding member 12 and the lower holding member 13 preferably have slack. With slack in the hollow fiber membranes 11, the filtration apparatus can not only enable the hollow fiber membranes 11 to swing and to be spaced apart to allow passage of gas therebetween, but can also enable the hollow fiber membranes 11 to vibrate and improve the cleaning effect. Also, with slack in the hollow fiber membranes 11, the filtration apparatus can easily and reliably hold the lower holding members 13 using the lower guide rails 4b.

When there is slack in the hollow fiber membranes 11, the lower limit of the ratio of the average effective length of the hollow fiber membranes 11 to the distance between the upper holding member 12 and the lower holding member 13 during use is preferably 1.01 and more preferably 1.02. The upper limit of this ratio is preferably 1.2 and more preferably 1.1. If the ratio is below the lower limit, the hollow fiber membranes 11 may not sufficiently swing in frictional contact with gas flow. This means that the hollow fiber membranes 11 may not be spaced apart to allow gas to pass therebetween. On the other hand, if the ratio exceeds the upper limit, the cleaning effect may not be significantly improved, and the filtration modules 1 may be difficult to handle during mounting or removal. Note that the “distance between the upper holding member 12 and the lower holding member 13 during use” refers to the average linear distance between both ends of the effective part of the hollow fiber membranes 11.

(Upper Holding Member)

The upper holding member 12 of each filtration module 1 is configured to secure the upper ends of the hollow fiber membranes 11. The upper holding member 12 includes a casing that opens at the bottom to allow upward insertion of the upper end portion of the hollow fiber membranes 11. The upper holding member 12 has a resin composition therein, with which the gaps between the casing and the hollow fiber membranes 11 and also between the hollow fiber membranes 11 are filled. Specifically, the upper holding member 12 and the hollow fiber membranes 11 are formed into a single unit by inserting the hollow fiber membranes 11, which are bonded into a bundle at the upper end portion thereof with a resin composition in advance, into the casing, and then charging an additional resin composition into the gap between the casing and the existing resin composition or hollow fiber membranes 11. The upper holding member 12 has a drain nozzle (not shown). The drain nozzle may be provided at any position. For example, the drain nozzle may be positioned to protrude from the side wall of the upper holding member 12 in the axial direction and extend along the axial direction. Alternatively, the drain nozzle may be positioned to protrude from the top of the upper holding member 12. The upper holding member 12 is hermetically sealed, except for a communicating portion communicating with the hollow fiber membranes 11 and the opening of the drain nozzle. A distributing pipe (not shown) is connected to the drain nozzle. The filtration apparatus is configured to allow the filtered liquid to be drawn out through this distributing pipe.

As illustrated in FIGS. 7 and 8, the upper holding member 12 preferably has a pair of recessed portions 16 on both sides thereof, into which the upper guide rails 4a are fitted. Specifically, the upper holding member 12 preferably has the recessed portions 16 extending in the horizontal direction, with the central axis therebetween, or more specifically, axially extending while facing each other along the X-direction in FIG. 1. The pair of recessed portions 16 formed in the upper holding member 12 enables the filtration apparatus to facilitate engagement of the upper guide rails 4a with the upper holding member 12. In particular, with this configuration in which the upper guide rails 4a are formed as a pair of round rods arranged in parallel and, at the same time, the recessed portions 16 into which the respective round rods are fitted are formed on both sides of the upper holding member 12, the filtration apparatus can easily and reliably enable the upper guide rails 4a to engage with the upper holding member 12.

The lower limit of a longitudinal length L₃ of the upper holding member 12 is preferably 400 mm and more preferably 600 mm. The upper limit of the longitudinal length L₃ is preferably 1300 mm and more preferably 1100 mm. If the longitudinal length L₃ is below the lower limit, the upper holding member 12 may not be able to communicate with a sufficient number of hollow fiber membranes 11 and sufficient filtration efficiency may not be achieved. On the other hand, if the longitudinal length L₃ exceeds the upper limit, the filtration modules 1 may be difficult to handle.

The lower limit of an average width L₄ of the upper holding members 12 is preferably 15 mm and more preferably 20 mm. The upper limit of the average width L₄ of the upper holding members 12 is preferably 110 mm and more preferably 85 mm. If the average width L₄ of the upper holding members 12 is below the lower limit, the upper holding members 12 may not be able to communicate with a sufficient number of hollow fiber membranes 11 and sufficient filtration efficiency may not be achieved. On the other hand, if the average width L₄ of the upper holding members 12 exceeds the upper limit, bubbles discharged from the cleaning module 2 may not be accurately supplied to the center of the bundle of the hollow fiber membranes 11.

(Lower Holding Member)

The lower holding member 13 is configured to hold the lower ends of the hollow fiber membranes 11. As in the case of the upper holding member 12, the lower holding member 13 is formed by charging a resin composition into the gaps between the casing and the hollow fiber membranes 11 and also between the hollow fiber membranes 11. The lower holding member 13 also has a drain nozzle (not shown). The drain nozzle may be provided at any position. For example, the drain nozzle may be positioned to protrude from the side wall of the lower holding member 13 in the axial direction and extend along the axial direction. Alternatively, the drain nozzle may be positioned to protrude from the bottom of the lower holding member 13. The lower holding member 13 is hermetically sealed, except for a communicating portion communicating with the hollow fiber membranes 11 and the opening of the drain nozzle. A distributing pipe (not shown) is connected to the drain nozzle. With this configuration in which the upper holding member 12 and the lower holding member 13 are connected to the respective distributing pipes, the filtration apparatus allows the filtered liquid to be drawn out from both the upper holding member 12 and the lower holding member 13.

As illustrated in FIGS. 7 and 8, the lower holding member 13 preferably has a pair of recessed portions 17 on both sides thereof, into which the lower guide rails 4b are fitted. Specifically, the lower holding member 13 preferably has the recessed portions 17 extending in the horizontal direction, with the central axis therebetween, or more specifically, axially extending while facing each other along the X-direction in FIG. 1. The pair of recessed portions 17 formed in the lower holding member 13 enables the filtration apparatus to facilitate engagement of the lower guide rails 4b with the lower holding member 13. In particular, with this configuration in which the lower guide rails 4b are formed as a pair of round rods arranged in parallel and, at the same time, the recessed portions 17 into which the respective round rods are fitted are formed on both sides of the lower holding member 13, the filtration apparatus can easily and reliably enable the lower guide rails 4b to engage with the lower holding member 13. Also, this configuration prevents the lower guide rails 4b from being interposed between the cleaning module 2 and the hollow fiber membranes 11, and allows bubbles fed from the cleaning module 2 to be accurately supplied to the hollow fiber membranes 11.

It is preferable, in the filtration apparatus, that the frame 3 be not present between adjacent ones of the lower holding members 13 arranged parallel to each other. It is particularly preferable, in the filtration apparatus, not only that the frame 3 be not present between adjacent ones of the lower holding members 13 arranged parallel to each other, but also that the frame be not present in regions directly below the spaces between the lower holding members 13. This configuration of the filtration apparatus can be obtained, for example, by fitting the pairs of upper and lower guide rails 4 into the corresponding pairs of recessed portions 16 and 17, the guide rails 4 being disposed between adjacent ones of the right-side upper frame member 3e, the left-side upper frame member 3f (which are upper frames), the right-side lower frame member 3i, the left-side lower frame member 3j (which are lower frames), the upper support frame member 3m, and the lower support frame member 3n (which form an upper-and-lower support frame pair). With the configuration in which the frame 3 is not present between the lower holding members 13, the filtration apparatus allows bubbles discharged from the cleaning module 2 to be accurately supplied through the spaces between the lower holding members 13 to the filtration modules 1.

The longitudinal length of the lower holding members 13 may be equal to the longitudinal length L₃ of the upper holding members 12. The average width of the lower holding members 12 may be equal to the average width L₄ of the upper holding members 12.

For ease of handling, such as transport, installation, or replacement, the filtration modules 1 may each have a coupling member for coupling the upper holding member 12 to the lower holding member 13. Examples of the coupling member include a metal support rod and a resin casing.

The filtration modules 1 may each be provided with a guide cover that surrounds the hollow fiber membranes 11. The guide cover can prevent cleaning bubbles from scattering as they move upward, and improve cleaning efficiency.

(Cover)

Although FIG. 1 illustrates the filtration apparatus with the filtration modules 1 exposed, the filtration apparatus may have a cover which entirely surrounds one or more filtration modules. The cover may be configured to cover only a pair of opposite sides, or may be configured to cover four sides. Note that the pair of opposite sides refers to right and left sides, or front and back sides, in FIG. 1. The cover can be attached to the frame.

<Applications>

The filtration apparatus described above can be used while being immersed in a filtration tank in which the liquid to be treated (or to be subjected to filtration) is stored. The filtration apparatus can be used, for example, for sewage treatment, industrial wastewater treatment, industrial tap water filtration, treatment of water for machine cleaning, pool water filtration, river water filtration, sea water filtration, sterilization or clarification for fermentation processes, filtration of foods, liquors, beers, and wines, cell separation from the fermenter for pharmaceutical production, filtration of dyeing water and dissolved dyes in dyeing industries, filtration of cultured animal cells, pre-filtration in pure water production processes using RO membranes, pre-filtration in processes using ion-exchange membranes, and pre-filtration in pure water production processes using ion-exchange resins. The pure water production processes include conversion of sea water into fresh water.

The filtration apparatus described above can be used as various types of filtration apparatuses, including an external-pressure type filtration apparatus in which the liquid to be treated passes from the pressurized outer side toward the interior of each hollow fiber membrane, an immersion-type filtration apparatus in which the liquid to be treated passes toward the interior of each hollow fiber membrane because of osmotic pressure or internal negative pressure, and an internal-pressure type filtration apparatus in which the liquid to be treated passes from the pressurized interior toward the outside of each hollow fiber membrane. The filtration apparatus described above is particularly suitable for use as an immersion-type filtration apparatus.

### Advantages

In the filtration apparatus, the lower guide rails 4b disposed between opposite faces of the right-side lower frame member 3i, the left-side lower frame member 3j, and the lower support frame member 3n (lateral frame members) engage with corresponding ones of the lower holding members 13 to allow the filtration modules 1 to be held by the frame 3. This means that the bubbles Y supplied from the cleaning module 2 can come into direct contact with the filtration modules 1 without being blocked by other components. With this structure, impurities adhering to the hollow fiber membrane surfaces can be sufficiently removed.

In the filtration apparatus, the lower holding members 13 of the filtration modules 1 are positioned at the same height as the lateral frame members that support the lower holding members 13, with the lower guide rails 4b between the lateral frame members. The filtration apparatus has a structure in which at least part of the cleaning module 2 is suspended from the frame 3. Of all the lateral frame members, those positioned at the same height as the lower holding members 13 and configured to allow part of the cleaning module 3 to be suspended therefrom are the right-side lower frame member 3i, the left-side lower frame member 3j, and the lower support frame member 3n which are disposed at the lowest level. That is, in the filtration apparatus, there are no lateral frame members located below the filtration modules 1. Therefore, the filtration apparatus can secure, under the filtration modules 1, a flow path that is large enough to accommodate inflow of the liquid to be treated from therearound. Thus, with the filtration apparatus, filtration of the liquid to be treated can be done efficiently.

In the filtration apparatus, for example, the right-side lower frame member 3i is coupled to the aeration-tube support member 26 and the metal securing piece 30, with the belt-shaped securing members 25 and 29 therebetween. This makes it possible to secure a space under the lateral frame member, or specifically, for example, between the right-side lower frame member 3i and the aeration-tube support member 26, the space being large enough to accommodate flow of the liquid to be treated into the frame 3. This structure facilitates inflow of the liquid to be treated, for example, through the space between the right-side lower frame member 3i and the aeration-tube support member 26 and enhances filtration efficiency.

In the filtration apparatus, the lower guide rails 4b for holding the filtration modules 1 are disposed between opposite faces of the right-side lower frame member 3i, the left-side lower frame member 3j, and the lower support frame member 3n, which are lateral frame members. The lateral frame members can secure the filtration modules 1 with a high degree of reliability. That is, the right-side lower frame member 3i and the left-side lower frame member 3j are structured to restrict the movement of the filtration modules 1, at their bottom, in the X-direction. This enables the filtration modules 1 to be secured in place without using additional components for securing the filtration modules 1 inside the frame 3.

Also, in the filtration apparatus, the cleaning module 2 is structured to be suspended from the frame 3. This enables the frame 3 and the cleaning module 2 to be attached and removed together. For example, the right-side lower frame member 3i is coupled to the aeration-tube support member 26 and the metal securing piece 30, with the belt-shaped securing members 25 and 29 therebetween. Therefore, when the right-side lower frame member 3i is removed, the aeration-tube support member 26 and the metal securing piece 30 can be removed at the same time. This configuration, which enables neighboring components to be removed together, facilitates maintenance of the aeration tubes 22 and the intermittent bubble discharge units 23. This configuration also facilitates maintenance of the aeration-tube support member 26 and others that can be taken out together, and reattachment of these components. The components suspended from the frame 3, such as the aeration-tube support member 26 coupled to the belt-shaped securing members 25 and the metal securing piece 30 coupled to the belt-shaped securing members 29, contribute very little to the strength of the frame 3. Therefore, even when the suspended cleaning module 2 is removed, the strength of the frame 3 is maintained. This improves work efficiency and safety during maintenance which is carried out, with the cleaning module 2 removed.

### Other Embodiments

The embodiments disclosed herein should be considered illustrative, not restrictive, in all aspects. The scope of the present invention is defined by the appended claims, and is not limited to the configurations of the embodiments. All changes made within the appended claims and meanings and scopes equivalent thereto are intended to be embraced by the present invention.

For example, the suspension structure of the cleaning module including the aeration tubes may be of any form. Specifically, for example, the belt-shaped securing members 25 and 29 do not necessarily need to be bent at the lower parts thereof into an L-shape toward the inside of the frame 3. Also, the belt-shaped securing members 25 and 29 may be reversed in position. That is, the pair of belt-shaped securing members 25 from which the aeration-tube support member 26 is suspended may be disposed inside the belt-shaped securing members 29, forming a pair, from which the metal securing piece 30 is suspended. Although the intermittent bubble discharge unit 23 schematically illustrated in FIG. 5 is located below the filtration module 1, for example, the bubble outlets 32 and the lower holding member 13 may be positioned at the same height. In this case, for example, the intermittent bubble discharge units 23 may be arranged in such a manner as to allow the bubble outlets 32 to be positioned between adjacent ones of the filtration modules 1 in plan view.

The filtration modules of the filtration apparatus do not necessarily need to be arranged in two rows, and they may be arranged, for example, in a single row. The filtration apparatus does not necessarily need to have drain nozzles for both the upper holding member and the lower holding member. That is, the filtration apparatus may be configured such that only one of the upper and lower holding members has a drain nozzle and the filtered liquid is drawn out from only the holding member with a drain nozzle. The configuration of the holding member having no drain nozzle is not particularly limited. For example, this holding member may be configured to hold a plurality of hollow fiber membranes in such a manner as to close the openings of the hollow fiber membranes, or may be configured in such a manner that each one of hollow fiber membrane is bent and folded into a U-shape and the folded portion is provided with a rod member for folding it.

The cleaning module of the filtration apparatus may be, for example, a jet-type gas diffuser that ejects a jet of gas through a diffuser or sparger, or a bubble jet nozzle that ejects a stream of water mixed with bubbles. When, for example, the filtration apparatus includes a plurality of cleaning modules, one or more of them may not necessarily need to be suspended from the frame and may be, for example, secured onto the frame member. The cleaning module of the filtration apparatus may include no intermittent bubble discharge unit. That is, for example, the filtration apparatus may be configured to allow bubbles from the aeration tubes to be directly supplied to the filtration modules.

Although it is preferable, in the filtration apparatus, that the frame be not present between the lower holding members, the frame may be present between some of the lower holding members.

The lower holding member does not necessarily need to have a pair of recessed portions into which the guide rails are to be fitted. For example, the distance between both sides of the lower holding member may change stepwise toward the bottom to allow the guide rails to be fitted thereto.

The mount structure of the upper holding members is not limited. For example, as in the case of the lower holding members, the upper holding members may be disposed between opposite faces of the upper support frame 3m and each of the right-side upper frame 3e and the left-side upper frame 3f, which are upper frames. The upper holding members of the filtration modules do not necessarily need to be disposed below the upper lateral frame members as in FIG. 2. That is, the upper holding members may be positioned at the same height as the right-side upper frame member 3e and others, which are upper lateral frame members, or may be even be positioned above them.

### REFERENCE SIGNS LIST

1: filtration module
2: cleaning module
3: frame
3a: front-side vertical frame member
3b: back-side vertical frame member
3c: front-side upper frame member
3d: back-side upper frame member
3e: right-side upper frame member
3f: left-side upper frame member
3g: front-side lower frame member
3h: back-side lower frame member
3i: right-side lower frame member
3j: left-side lower frame member
3k: front-side support frame member
3l: back-side support frame member
3m: upper support frame member
3n: lower support frame member
4: guide rail
4a: upper guide rail
4b: lower guide rail
11: hollow fiber membrane
12: upper holding member
13: lower holding member
16, 17: recessed portion
21: aeration tube header
22: aeration tube
23: intermittent bubble discharge unit
24: protruding hole portion
25, 29: belt-shaped securing member
26: aeration-tube support member
27: hole portion
28, 32: bubble outlet
30, 31: metal securing piece
40: hole
41, 42: securing member
X, Y: bubble

1: A filtration apparatus comprising:
a plurality of filtration modules each including a plurality of hollow fiber membranes aligned so as to extend in an up-and-down direction, a bar-like upper holding member configured to secure upper ends of the hollow fiber membranes, and a bar-like lower holding member configured to secure lower ends of the hollow fiber membranes;
a cleaning module configured to supply bubbles from below the filtration modules;
a frame including a plurality of vertical frame members disposed to extend in the up-and-down direction and a plurality of lateral frame members disposed to extend in lateral directions, the frame being configured to hold the filtration modules and the cleaning module; and
a plurality of lower guide rails configured to engage with the lower holding members and disposed between opposite faces of the lateral frame members,
wherein at least part of the cleaning module is suspended from the frame.

2: The filtration apparatus according to claim 1, wherein at least part of the cleaning module is suspended from at least one of the lateral frame members, with a plurality of belt-shaped securing members interposed therebetween, the belt-shaped securing members being arranged to be spaced apart from each other.

3: The filtration apparatus according to claim 1, wherein at least one of the lateral frame members is disposed between the vertical frame members so as to be positioned outside the vertical frame members.

4: The filtration apparatus according to claim 1, wherein the cleaning module includes an aeration tube and an intermittent bubble discharge unit disposed above the aeration tube.
